(19) United States
(12) Patent Application Publication
(10) Pub. No.: US 2004/0026158 A1
(43) Pub. Date: Feb. 12, 2004

(54) Vehicle system and axle guide module for a vehicle steering system

(76) Inventors: Peter Rieth, Eltville (DE); Alfred Eckert, Mainz-Hechtsheim (DE); Stefan A. Drumm, Saulheim (DE); Jurgen Bohm, Oberneisen (DE); Johann Jungbecker, Badenheim (DE); ralf Schwarz, Heidelberg (DE); Oliver Hoffmann, Frankfurt (DE); Joachim Nell, Hanau (DE); Steffen Linkenbach, Eschborn (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/240,257

(22) PCT Filed: Mar. 23, 2001
(86) PCT No.: PCT/EP01/03354

(30) Foreign Application Priority Data
Mar. 27, 2000 (DE) 100 15 233.3

(51) Int. Cl. B62D 5/06

(52) U.S. Cl. 180/402; 180/405

(57) ABSTRACT

The vehicle steering system includes a steering operating device operable by the driver, in particular a hand steering wheel, each one electromechanical actuator for controlling of each steerable wheel of a wheel pair on a steerable vehicle axle at the right and left side of a vehicle body, means which, in the event of failure or a malfunction of one of the two actuators associated with a steerable vehicle axle, ensure the control of the two vehicle wheels of this vehicle axle by the respectively other, still functioning actuator, at least one set-value transducer for a steering angle being adjusted that is operable by the steering operating device, at least one actual-value transducer recording the steering angle of the vehicle wheels, a central control unit which controls the electromechanical actuators in dependence on a comparison of a signal of the actual-value transducer (actual value) with a signal of the set-value transducer (set value), and a data transmission unit which establishes a data communication between the central control unit and the electromechanical actuators.

### TECHNICAL FIELD

The present invention generally relates to steering systems and more particularly relates to a vehicle steering system and an axle guide module for a vehicle steering system.

### BACKGROUND OF THE INVENTION

Modern automobiles, especially passenger vehicles, are usually equipped with hydraulic power steering systems having a hand steering wheel that is mechanically coupled directly to steerable vehicle wheels.

It is known in the art to couple the steerable vehicle wheels to a servo motor for driving purposes, said motor being controlled in dependence on the forces or moments transmitted between the hand steering wheel and the steered vehicle wheels in order to reduce the manual force that is necessary for the respective steering maneuver at the steering operating device.

Further, vehicle steering systems are disclosed wherein the steering operating device and the steered vehicle wheels are coupled only by way of a control system, and wherein a mechanic connection between the hand steering wheel and the vehicle wheels is not present.

Frequently, however, a mechanical direct coupling between the hand steering wheel and the steered vehicle wheels is not completely eliminated. In such designs, a separate mechanical direct coupling is established only when a system fault occurs. When a malfunction is detected in the controlled system which latter performs constant self-monitoring for defects, the mechanical direct coupling is automatically activated to become effective. Thus, the mechanical direct coupling provides a ‘mechanical emergency mode’ in the event of possible malfunctions of the controlled system.

### BRIEF SUMMARY OF THE INVENTION

An object of the present invention is to disclose a favorable embodiment for a vehicle steering system and a steerable vehicle axle that has no mechanic connection between the hand steering wheel and the vehicle wheels while still ensuring a safe and reliable steering function.

The above object is achieved by a vehicle steering system including a steering operating device operable by the driver, in particular a hand steering wheel, at least one actuating force simulator, each one electromechanical actuator for controlling of each steerable wheel of a wheel pair on a steerable vehicle axle at the right and left side of a vehicle body, with means which, in the event of failure or a malfunction of one of the two actuators associated with a steerable vehicle axle, ensure the control of the vehicle wheels of this vehicle axle by the respectively other, still functioning actuator, with at least one set-value transducer for a steering angle being adjusted that is operable by the steering operating device, with at least one actual-value transducer recording the steering angle of the vehicle wheels, with a central control unit which controls the electromechanical actuators in dependence on a comparison of a signal of the actual-value transducer (actual value) with a signal of the set-value transducer (set value). Comparatively short regulating distances and high regulating speeds can be achieved by means of the vehicle steering system of the present invention.

Because there is no mechanical connection between the steering operating device and the electromechanical actuators in this vehicle steering system, the driver loses the feedback about the respective steering conditions that is usually imparted to him/her. Therefore, it is necessary to arrange for at least one actuating force simulator or to render the steering operating device actively operable. Thus, the actuating force exerted on the steering operating device can influence the set-value specification for the steering angle and, in addition, an intuitive feedback of one or more driving-dynamics quantities may occur.

In a favorable embodiment of the present invention, each electromechanical actuator is respectively fed by an independent energy supply source. Preferably, the independent energy supply sources are two independent vehicle batteries that preferably have an electrical voltage, especially about 36 to 42 volt, being higher compared to a conventional electrical system.

According to an advantageous embodiment of the present invention, the central control unit has a ‘fail-silent’ design and includes a redundant processor unit.

The term ‘redundant processor unit’ refers to a processor unit with a redundant architecture, hence, with two processors. The expression ‘fail-silent’ implies in this arrangement that the central control unit keeps silent when a fault occurs and does not execute any control functions on other system components. Malfunctions are detected by an independent testing of the central control unit, in particular by a fault detection circuit, e.g. a comparator, which compares the values or signals output by the two processors of the redundant processor unit. In the case of a malfunction of a processor that causes defined discrepancies of the two values or signals, the central control unit will disconnect independently (fail-silent).

The central control unit controls the actuators in dependence on at least one comparison between set values and actual values and, as the case may be, further quantities. To this end the central control unit will control the actuators so that an actuator performs an actuating stroke for the steering adjustment of the vehicle wheels, with the actual value of the steering angle sensed by the actual-value transducer being adjusted to the steering angle set-value predetermined by the set-value transducer and predetermined by an actuation of the steering operating device. If necessary, this set value may be modified by further quantities in order to balance the disturbing forces that act on the vehicle, for example, at least in part. Advantageously, further quantities are the speed of the vehicle, driving stability, especially the yaw torque or the sideslip angle of the vehicle, road conditions, and/or other influences, such as e.g. the side wind. It is also arranged for to integrate a damping function for compensating an excessively vigorous actuation of the steering operating device by the driver with the help of a corresponding control function.

Preferably, however, the steering angle set value for the actuator is variably predefined at least in dependence on the actuating force exerted on the steering operating device and on the instantaneous vehicle longitudinal speed in order to achieve a speed-responsive steering ratio and steering boost. To this end, the central control unit is connected to sensors on the inlet side, having signals that correlate to steering forces developing at the steerable vehicle wheels. For example, the sensors can sense the forces in the actuators. Besides, the central control unit on the inlet side may still be connected to sensors permitting to detect parameters to predefine such as the transverse acceleration or the yaw speed of the vehicle.

According to a favorable embodiment of the present invention, the actuators are ‘fail-silent’ and include at least one electromechanical actor and respectively one redundant electronic modular unit.

The term ‘a redundant electronic modular unit’ herein refers to a modular unit with a redundant architecture, with preferably two processors. The term ‘fail-silent’ herein implies that the electronic modular unit keeps silent when a fault occurs and will not execute any control functions on other system components. Malfunctions are detected by an independent testing of the central control unit, and a fault detection circuit, e.g. a comparator, will detect possible discrepancies between the values or signals output by the two processors of the redundant processor unit, which will then result in independent disconnection of the electronic modular unit (fail-silent).

Thus, the vehicle steering system of the present invention in total includes preferably at least four processors associated with the actuators and two processors associated with the central control unit.

According to a preferred embodiment of the present invention, the electronic modular units, in particular processor units, of the actuators will perform a fault detection based on local, actor-related signals such as actor current or actor position and, when a fault is detected, will emit a corresponding report to the vehicle steering system and disconnect the faulty actuator. Therefore, the actuators are open in their de-energized condition. This means that the disconnected actuator can be ‘entrained’ passively by the still operative actuator during a steering operation.

According to a preferred embodiment of the present invention, the vehicle steering system includes two set-value transducers for the steering angle being adjusted and two actual-value transducers recording the steering angle of the vehicle wheels. In the event of failure of one set-value or actual-value transducer, the respectively other still operative set-value and/or actual-value transducer is able to produce a signal for controlling the steering system.

In an advantageous embodiment of the present invention, the set-value transducer(s) for the steering angle being adjusted and the actual-value transducer(s) recording the steering angle of the vehicle wheels have a redundant design.

The term ‘redundant set-value transducer’ herein refers to a set-value transducer, preferably a sensor for the angle of rotation of the hand steering wheel that has at least two probes for the angle of rotation and at least one analog-digital converter (A/D converter) and a comparator. The redundant set-value transducer is favorably designed to be ‘fail-silent’. This means that the set-value transducer keeps silent in a case of fault and does not execute control functions with respect to other system components. Malfunctions are detected by independent testing of the set-value transducer, and the comparator is used to detect possible discrepancies between the values or signals found by the probes, which will then cause an independent deactivation of the set-value transducer (fail-silent). The signal of the respectively other, still operative redundant set-value transducer is then used to control the steering system.

In a favorable embodiment of the present invention, a data bus that is of double design at least between the actuators and the central control unit is provided as a data transmission unit. This means that each actuator is connected to two data bus lines to ensure that in the event of a fault in one bus, the respectively other data bus is available for governing the steering system.

In another preferred aspect of the present invention, each one data bus is provided as a data transmission unit between the actuators and the central control unit. In this arrangement, respectively one actuator is coupled to each one bus so that the two actuators are controlled by way of each one data bus that is principally independent of the other bus. Preferably, the two buses are separated from each other to prevent an electric short-circuit at a (joint) plug, for example a joint plug at the inlet and outlet of the central control unit, which would jeopardize the functioning of the overall system. In this embodiment, it is also arranged for that the buses are coupled in one separate, preferably redundant vehicle processor. This means in this central vehicle processor, which preferably can also control still further vehicle functions such as the brake system or engine management, both buses of the steering system are combined, and available data is evaluated and exchanged by way of the two buses. This way it is submitted to each of the participants connected to the buses which participants exist and, possibly, which status they have, with the result that in the event of a malfunction or failure of one participant the other participants are able to react appropriately.

According to a preferred aspect of the present invention, the data buses are a part of a vehicle bus system, especially CAN.

According to a preferred aspect of the present invention, the central control unit is connected to a vehicle bus system, especially CAN, to receive data about the especially current vehicle condition.

In a preferred aspect of the present invention, the steering operating device is connected to a mechanical or mechanic-hydraulic first actuating force simulator in terms of driving for the purpose of simulating a certain predefined operating resistor, especially a variable resistor, and the steering operating device is connected in terms of effect to an electrically operable, preferably parameter-responsive second actuating force simulator which controls the second actuating force simulator in accordance with at least the actual value and, possibly, further signals, in particular dynamic vehicle condition signals, such as vehicle speed, vehicle yaw angle, vehicle longitudinal or transverse acceleration, or road condition signals, such as the current static friction. Thus, the actuating force simulator has a ‘fail-safe’ design: the first actuating force simulator is used as a fall-back strategy means upon failure of the second actuating force simulator. Preferably, the first actuating force simulator includes elastic means in order to impress an actuating force on the steering operating device which is at least approximately common to the driver. Advantageously, the first actuating force simulator is so designed that the elastic resistance rises progressively when the steering operating device is being moved away from a center position, especially turned away therefrom.

It is arranged for in a preferred aspect of the present invention that the central control unit is connected to an electronic vehicle brake system, especially an electromechanical brake system (EMB).

In a preferred aspect of the present invention, the respectively two electromechanical actuators in connection with at least one steering rod (tie rod) are configured as an axle guide module for controlling each one steerable wheel of a wheel pair on a steerable vehicle axle at the right and left side of a vehicle body.

According to a preferred aspect of the present invention, the central control unit of the vehicle steering system and a central control unit of the electronic vehicle brake system are arranged as individual modules in one joint housing.

According to a preferred aspect of the present invention, a joint central control unit is provided for the vehicle steering system and the electronic vehicle brake system.

According to a preferred aspect of the present invention, the respectively two electromechanical actuators in connection with at least one steering rod are configured as an axle guide module for controlling each one steerable wheel of a wheel pair on a steerable vehicle axle at the right and left side of a vehicle body.

The object of the present invention is achieved by an axle guide module including two electromechanical actuators having one electric motor each and being associated with each one steerable wheel of a wheel pair on a steerable vehicle axle at the right and left side of a vehicle body and being connectable with each other by way of a coupling device so that the two steerable wheels are adapted to be directed by way of one single actuator.

In a preferred aspect of the present invention, the vehicle steering system includes at least one steering rod designed as a thrust rod which, in its extension, is connectable to tie rods for the two steerable wheels and wherein the two electric motors are provided coaxially relative to the steering rod axis. Each electric motor includes a rotor which is connected to a rotation/translation converter by way of a transmission device for applying an engine torque to the at least one steering rod in order to ensure the steering function of the axle guide module by way of displacing the at least one steering rod upon actuation of at least one electric motor.

The transmission device includes means for the direct coupling to the rotation/translation converter according to a preferred aspect of the present invention.

According to a preferred aspect of the present invention, the rotation/translation converter is a threaded gear, preferably a screw thread.

According to a preferred aspect of the present invention, the rotation/translation converter is connected in terms of driving to at least one steering rod (threaded rod) which is configured as a threaded rod at least in an area or partial area of the axle guide module, said steering rod being encompassed by at least one threaded nut and connected thereto by way of rollers having a profile that mates with the thread of the at least one threaded rod.

The transmission devices are gear units or clutches, preferably planetary gears according to a preferred aspect of the present invention.

In a preferred aspect of the present invention, the electric motor comprises a stator with a winding coaxially relative to the steering rod and includes a rotor pivoted about the stator and having permanent magnets, preferably rare earth magnets, especially cobalt-samarium or neodymium magnets.

In a favorable embodiment of the present invention, the electric motor is an electronically commutated d-c motor preferably designed as a transverse flux motor.

In a preferred aspect of the present invention, the rotor of the electric motor is form-lockingly rotatorily coupled to the threaded nut of the threaded gear in a clearance-free manner by way of the transmission device.

In a preferred aspect of the present invention, the rotor of the electric motor is configured as a part of the transmission device, preferably as a sun wheel of a planetary gear assembly, at least in a partial area.

In a preferred aspect of the present invention, at least two electronic units are associated with each actuator, and in the event of a fault of one of the two electronic units, the respectively other still operative electronic unit assumes the control of the actuator.

In a preferred aspect of the present invention, the turning movement of the wheels is performed by the still operative actuator or the electric motor, respectively, in the event of a fault of an actuator or an electric motor, respectively, and the modular unit of the defective actuator is entrained purely mechanically by a mechanical coupling by way of the coupling device, in particular by means of the at least one threaded nut and the at least one threaded gear.

In a preferred aspect of the present invention, at least one bearing, preferably an axial angular ball bearing, is provided to accommodate the resulting setting forces at the at least one steering rod, the said bearing having an inner ring to incorporate the threaded nut and at least one component of the transmission device, preferably of planet carriers of a planetary gear or a clutch, as well as an outer ring to introduce the resulting setting forces into a housing or a component of the axle guide module that is operatively connected to the housing.

In a preferred aspect of the present invention, at least one force sensor is associated with the outer ring of the bearing in order to sense the active setting forces and to provide a feedback about these determined setting forces to the manual operating device, preferably the hand steering wheel of the vehicle steering system.

In a preferred aspect of the present invention, the stator of the electric motor is arranged at a housing or a component of the axle guide module that is operatively connected to the housing, and the rotor of the electric motor is pivoted by way of an immovable bearing and a movable bearing to a housing or a component of the axle guide module that is operatively connected to the housing.

In a preferred aspect of the present invention, each actuator includes as transmission devices a planetary gear having a sun wheel that is designed as component part of the rotor and is supported on a ring gear that is a part of the outer ring of a bearing to accommodate the setting forces.

In a preferred aspect of the present invention, the two actuators are provided with one joint steering rod configured as a thrust rod, preferably one joint threaded rod, and one joint rotation/translation converter, in particular one joint threaded nut and joint roll bodies arranged inbetween, in order to ensure the steering function of the axle guide module upon actuation of at least one actuator by way of displacing the steering rod.

In a preferred aspect of the present invention, associated with each of the two actuators is each one steering rod configured as a thrust rod, preferably each one threaded rod, and each one rotation-translation converter, especially each one threaded nut and roll bodies respectively arranged therebetween, and associated with both actuators is a coupling device to connect the two actuators and to ensure the steering function of the axle guide module during actuation of an actuator by displacing the two connected steering rods.

In a preferred aspect of the present invention, the coupling device includes an electromechanical clutch having clutch discs which are operatively connected to inner rings of two bearings, preferably axial angular ball bearings, and are used to accommodate the setting forces that act on the two steering rods, wherein in the de-energized condition the two clutch discs are pressed against each other by an elastic means, preferably a compression spring, and constitute an operative connection between the two rotation/translation converters of the actuators.

In a preferred aspect of the present invention, a defined maximum setting range of the two steering rods with respect to each other is predetermined by means of mechanic stops that allow only a defined difference in travel of the two steering rods in relation to each other.

In a preferred aspect of the present invention, at least one partial area of one of the two steering rods is configured as a hollow shaft having two stops and a hollow space which is penetrated by a coupling rod connected to the other steering rod, said coupling rod including an end piece close to the hollow shaft that has two inner stops and two outer stops allowing only a defined difference in travel of the two steering rods in relation to each other in interaction with two entrainer discs adapted to bear against the stops and a compression spring that is supported on the entrainer discs.

It is arranged for in a preferred aspect of the present invention that, with the electromechanical clutch closed, the coupling rod defines an initial position, meaning the compression spring has a maximum length and is supported due to the two entrainer discs on two outer stops of the coupling rod and the two stops of the hollow shaft, and that with the electromechanical clutch being open, a first and a second end position is defined, said positions fixing the maximum difference in travel of the steering rods. In the first end position, the compression spring has a minimum length and, by way of the two entrainer discs, is supported on a first stop of the hollow shaft, on the one hand, and on a second outer stop of the coupling rod, on the other hand, while in the second end position, the compression spring has a minimum length and, by way of the two entrainer discs, is supported on a second stop of the hollow shaft, on the one hand, and on a first outer stop of the coupling rod, on the other hand.

### BRIEF DESCRIPTION OF THE DRAWINGS

FIG. 1 is a schematic view of the vehicle steering system of the present invention.

FIG. 2 is a circuit diagram view of the vehicle steering system of the present invention with redundant control components.

FIG. 2a is a circuit diagram view of another embodiment of the vehicle steering system of the present invention with redundant control components.

FIG. 3 is a circuit diagram view of the vehicle steering system of the present invention in connection with an electromechanical brake.

FIG. 4 is a view of the vehicle steering system of the present invention with two axle guide modules with two actuators.

FIG. 5 is a cross-section taken through an axle guide module of the present invention with a continuous steering rod, a screw thread, and with planetary gears.

FIG. 6 is an enlarged view of a cut-away portion of the cross-section taken through the axle guide module of the present invention as shown in FIG. 5.

FIG. 7 is a cross-section taken through an axial guide module of the present invention with a continuous steering rod, a screw thread, and with clutches instead of the planetary gears.

FIG. 8 is a cross-section taken through an axle guide module of the present invention with a divided steering rod, with screw threads, and with planetary gears.

FIG. 9 is an enlarged view of a cut-away portion of the cross-section taken through the axle guide module of the invention as shown in FIG. 8.

FIG. 10 shows the vehicle steering system of the present invention with an axle guide module with two actuators for an adjustment on the individual wheel.

FIG. 11 is an enlarged view of the clutch shown in FIG. 9 and FIG. 10 between the right and the left actuator.

FIG. 12 is a view of the axle guide module, as shown in FIG. 9 and FIG. 10, in a first position.

FIG. 12a is an enlarged view of the axle guide module shown in FIG. 12.

FIG. 13 is a view of the axle guide module, as shown in FIG. 9 and FIG. 10, in a second position.

FIG. 13a is an enlarged view of the axle guide module shown in FIG. 13.

FIG. 14 is a view of the axle guide module, as shown in FIG. 9 and FIG. 10, in a third position.

FIG. 14a is an enlarged view of the axle guide module shown in FIG. 14.

### DETAILED DESCRIPTION OF THE PREFERRED EMBODIMENTS

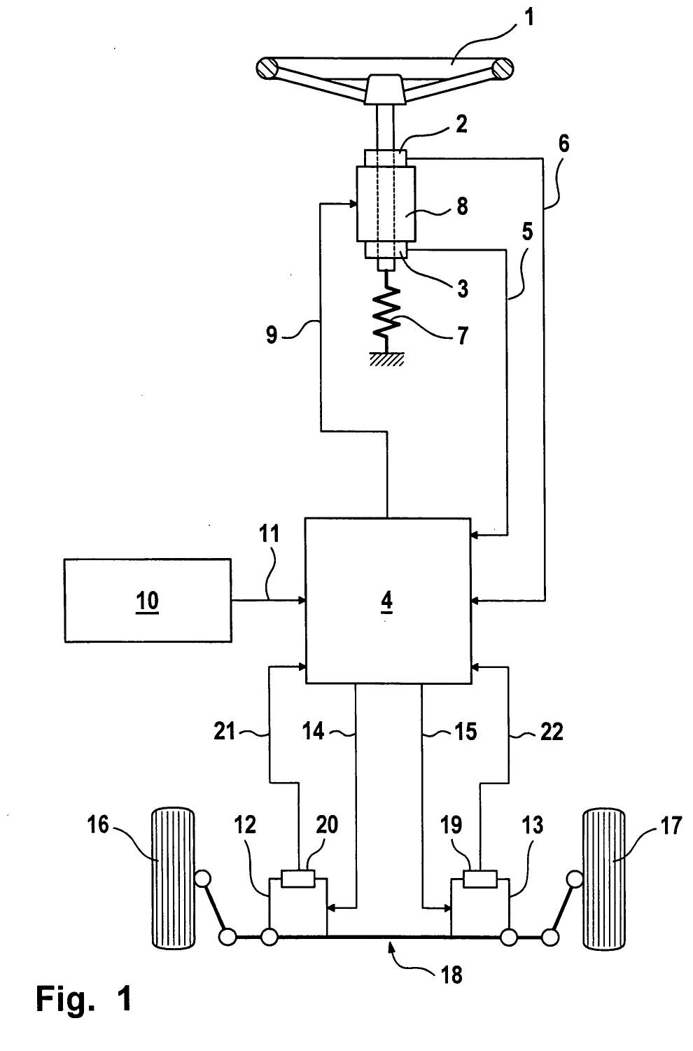

FIG. 1 shows a schematic view of the vehicle steering system of the present invention. The driver actuates the hand steering wheel 1 or a similar operational control, e.g. a side stick, used to predefine his/her driving direction request. The driving direction request is in this case sensed redundantly by two sensors 2, 3 as an angle of rotation of the hand steering wheel 1 and reported electronically to a central control unit 4 by means of the data transmission lines 5, 6. The driver receives a haptic feedback upon steering actuation by way of a first passive actuating force simulator 7. This feedback may be boosted or weakened, as required, by way of a second electromechanical actuating force simulator 8. The central control unit 4 controls the second electromechanical actuating force simulator 8 by way of the data transmission line 9. Signals of a vehicle speed detection device 10 are preferably sent to the central control unit 4 by way of a data transmission line 11. Subsequently, algorithms are executed in the central control unit 4 varying the steering torque in response to the speed. The driver's request is evaluated in the central control unit 4, converted into a steering angle (set value) for two actuators 12, 13 and sent to the actuators 12, 13 by way of a data transmission line 14, 15. Each one actuator 12, 13 is provided per steerable wheel 16, 17 of a steerable axle 18 so that principally an individual control of the right wheel 16 and the left wheel 17 is also possible. Appropriate sensors 19, 20 transmit the current actual value of the wheel position of the steerable wheels 16, 17 to the central control unit 4 by way of each one data transmission line 21, 22.

Thus, there is no direct mechanical connection between the hand steering wheel 1 and the steerable wheels 16, 17. The mechanical uncoupling of the hand steering wheel 1 from the steerable axle 18, as disclosed in the present invention, obviates the need for the steering column, with the result of better mounting conditions in the front part of the vehicle and a better performance of the vehicle in a crash. The condition of uncoupling between the driver and the wheel 16, 17 prevents an irritation of the driver due to vibrations of the steering wheel induced by wheel 16, 17. In addition, this steering permits integrating a steering assistant function to compensate for an overreaction of the driver during steering actuation. With a corresponding rating and connection to a driving stability control (ESP), a coupled control may be achieved in a particularly favorable manner by the electronic control of the actuators 16, 17. The steering angle is then changed also to enhance driving stability. Further, it is advantageous with the steering system of the present invention that it permits achieving a relatively small turning circle of the vehicle and, additionally, a relatively high degree of course stability of the vehicle due to the uncoupling between right and left wheel 16, 17 of the steerable axle 18. In addition, the assembly of the steering system of the present invention compared to prior art steering systems is simplified because no mechanic connection is needed between the steerable axle 18 and the hand steering wheel 1.

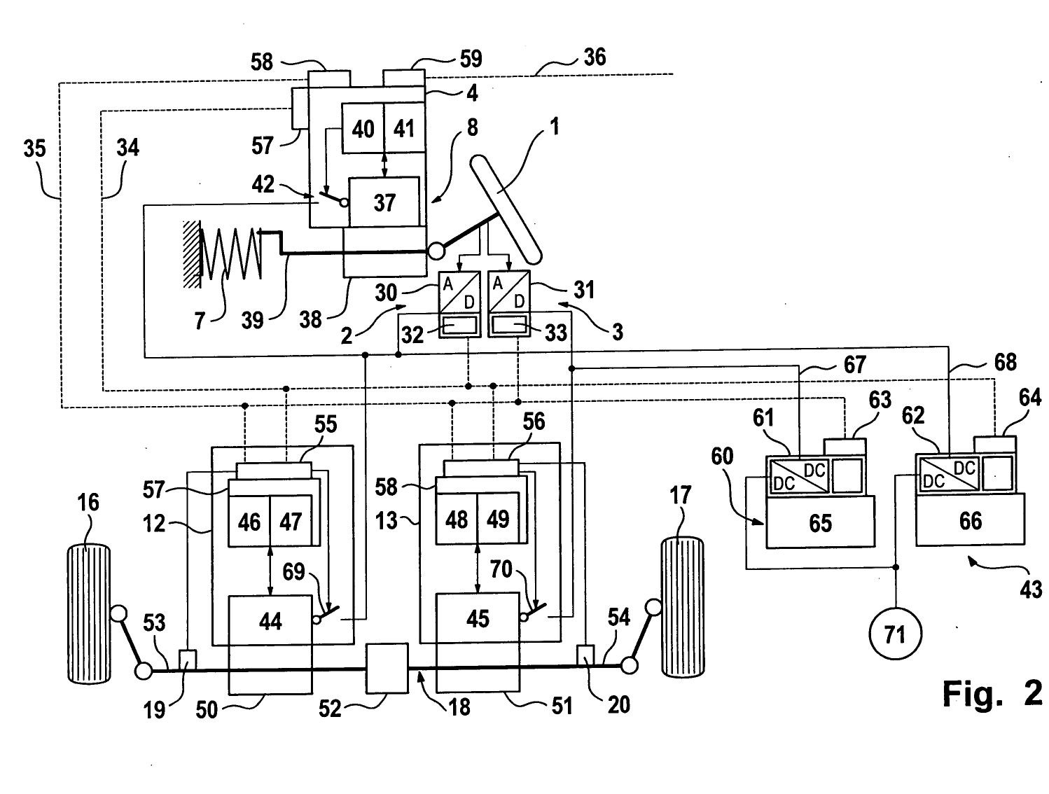

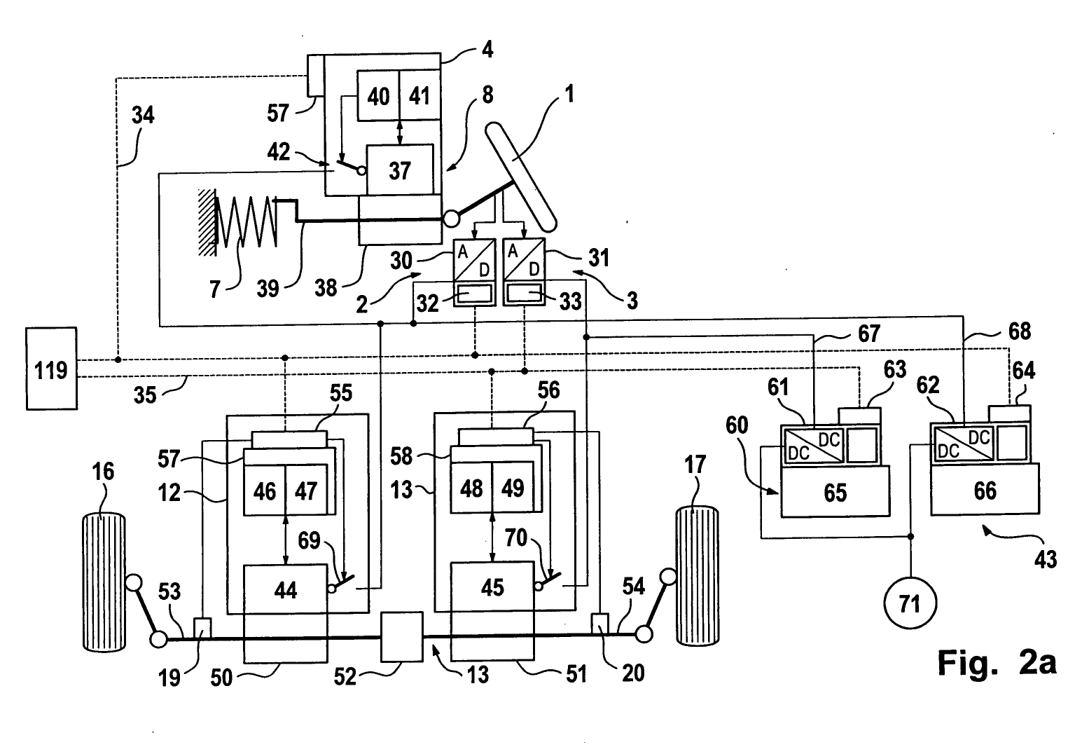

FIG. 2 illustrates the system concept of the vehicle steering system of the present invention, with redundant sensor technology and a redundant evaluating circuit, and it applies for this illustration and the following one that components of the vehicle system similar to FIG. 1 have been assigned like reference numerals. The driver actuates the hand steering wheel 1 to predefine his/her driving direction request. Two sensors 2, 3 respectively including one A/D converter 30, 31 and one output 32, 33 redundantly sense this request set by the driver. The signals of the sensors 2, 3 are sent to the central control unit 4 electronically, preferably by way of a redundant bus system 34, 35 (two data lines). Algorithms varying the steering torque in dependence on speed (parameter steering) are executed in the central control unit 4 that also actuates the second electromechanical actuating force simulator 8. In addition, a vehement steering reaction of the driver may be damped to a greater degree (steering assistant). Also, a yaw response due to lateral wind may be compensated by way of an additional steering angle because preferably information about the current vehicle condition may be read in via the vehicle bus system, especially CAN 36.

A resetting torque slightly rising over the entire steering angle range and, in the event of rapid steering movements, also a torque damping the movement is generated by way of the first passive actuating force simulator 7. This reaction can be boosted or weakened as required by way of a second electromechanical actuating force simulator 8. To this end, a motor 37 produces a torque by way of a gear unit 38 and applies it to an axle 39 connected to the hand steering wheel 1. This permits the system to provide the driver e.g. with a feedback about the situation on the road, such as aquaplaning, curbstone, low coefficient of friction.

The driver's request is evaluated in the central control unit 4 and converted into control signals for the actuators 12, 13. The steering angle between the right and the left wheel 16, 17 of a steerable axle 18, preferably the front axle 18, can be adjusted irrespective of each other, at least within certain limits, due to the actuators 12, 13 which are principally independent according to the present invention. This renders it possible to realize an optimum effect as regards turning circle, tire wear, and straight travel.

The central unit 4 is favorably designed according to the ‘fail-silent architecture’ and has two redundant processors 40, 41. Favorably, the actuating unit has a ‘fail-safe’ architecture. This means that the second, electromechanical actuating force simulator 8 is open in its de-energized condition and adapted to be deactivated by a switch 42, and it does not produce a torque when the electric energy source 43 fails. In the case of a fault, the driver experiences a haptic feedback by the first actuating force simulator 7. In the absence of a fault, the forces are determined which the actuator 12, 13 furnishes. This is preferably done by measuring the currents at the motors 44, 45 of the actuators 12, 13 and the setting travel at the actuators 12, 13. The central control unit generates from the determined forces actuating signals for the second, electromechanical actuating force simulator 8. The driver thus receives a haptic feedback about the coefficient of friction acting on the roadway, which is superposed with respect to the first, passive actuating force simulator 7.

Each of the actuators 12, 13 includes an electric motor 44, 45, with a housing preferably accommodating a redundant electronic unit 57, 58 with power output stages and logic units, in particular, with two processors 46-49 being respectively provided for each electronic unit 57, 58. The electronic units 57, 58 drive the actuators. The power takeoff is by way of a gear unit 50, 51 possibly comprising a rotation/rotation gear unit and a rotation/translation gear unit (not illustrated herein) depending on the gear ratio needed. Both actuators, that means the electric motors 44, 45 and gear units 50, 51, may be arranged in one joint housing. In this case, a partition wall is arranged between the housing halves to prevent water that enters through a leaky seal from destroying the two actuators. Interposed between the actuators is a clutch 52 connecting, on the output side, the two gear units 44, 45 and allowing a defined twisting angle between the individual actuators. The twisting angle effects a different regulating distance for the right and the left tie rod side 53, 54. The twisting angle is limited mechanically because an actuator 12 or 13 can assume the task of steering from both actuators 12, 13 in the event of failure.

The electronics 46, 47, 48, 49 of the actuators 12, 13 and the electronics 40, 41 of the central control unit 4 each comprise inputs and outputs 55-58 for the two data transmission lines 34, 35 of the steering bus system. In addition, the central control unit 4 may comprise an input and output 59 for the data transmission line of the vehicle bus system, such as CAN. The data transmission lines 34, 35 of the steering bus system are also in connection with electronic modular units 61, 62 associated with the energy sources 43, 60 and including especially voltage converters and controllers as well as input and output 63, 64. Because the two independent energy sources, especially the two vehicle batteries 65, 66, supply electrical energy to each one actuator 12, 13 and each one electronic unit 40, 41 of the central control unit 4 by way of lines 67, 68, at least the control and functioning of an actuator 12 or 13 is ensured in the event of failure. Thus, it is possible for the respectively other actuator 12 or 13 to safeguard functioning of the steering system by way of the clutch 52 which is preferably de-energized in its position in the event of failure of an actuator 12 or 13, and the respectively non-operative actuator 12 or 13 is switched off by a normally open switch 69, 70. The two vehicle batteries 63, 64 are charged by way of a vehicle generator 71.

FIG. 2a illustrates another embodiment of the vehicle steering system of the present invention with redundant control components and a central vehicle processor 119. In contrast to the embodiment shown in FIG. 2, the actuators 12, 13 in FIG. 2a are coupled to each one bus 34, 35. It is favorable that a short circuit at the input and output of an actuator will not cause loss of operability of the overall system. The buses 34 and 35 are isolated also in this arrangement. Advantageously, a central vehicle processor 119 may also be provided, whereby the data of the principally independent buses 34, 35 are mutually transmitted in order that each participant of the bus systems is informed about which participants are still available to the system. This allows the participants to react appropriately to a failure of other participants and e.g. replace their function. Further, a mechanical actuating force simulator 7 is provided which is used as a ‘fall-back mode’ in the event of failure of the electromechanical actuating force simulator 7 (‘fail-safe’), which is controlled by the central control unit 4 that also has a redundant and ‘fail-silent’ design.

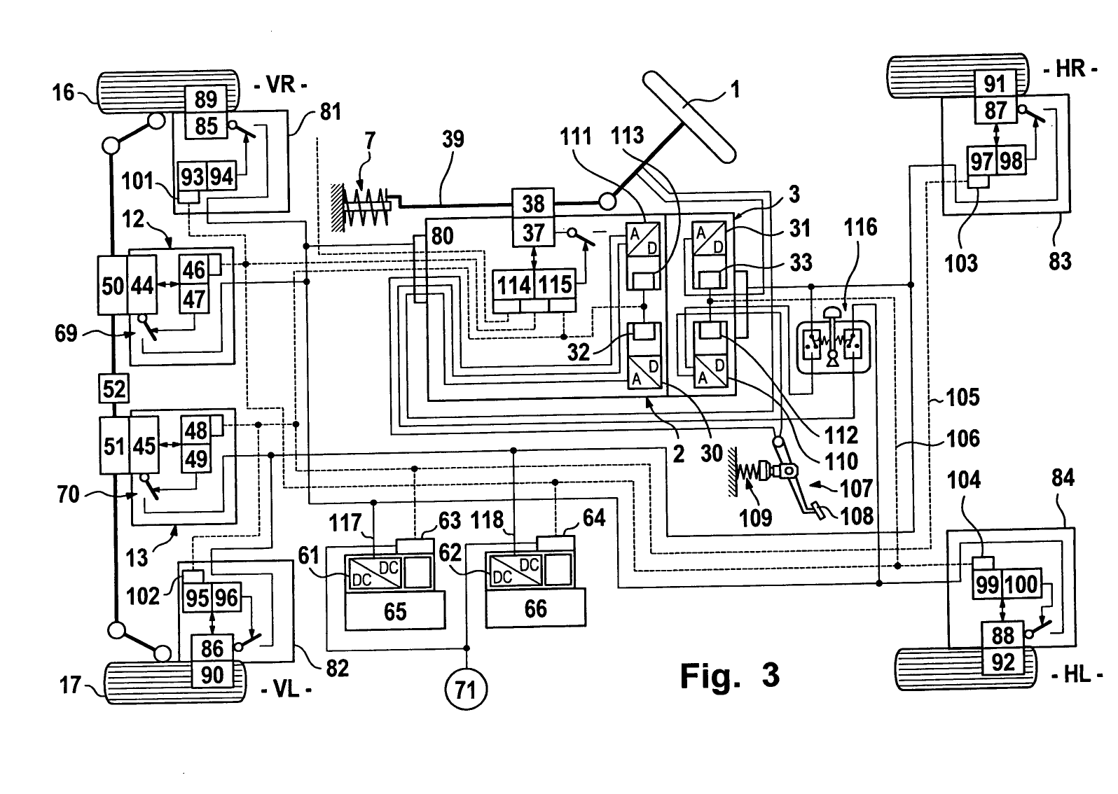

FIG. 3 shows a system wherein the steering system of the present invention is connected to an electromechanical brake system (EMB). The vehicle steering system basically corresponds to the system shown in FIG. 2, while in FIG. 3 a central control and regulating unit (central unit) 80 assumes the control and regulation of the vehicle steering system and the vehicle brakes.

The wheel brake modules 81-84 preferably comprise electric motors as actuators 85-88 that produce a defined brake force by way of gear units 89-92 and transmit it to the brake discs preferably by way of brake linings. The wheel brake modules 81-84 also comprise two processors 93-100 each, with inputs and outputs 101-104 to a combined brake and steering bus system 105, 106. The driver's braking request is transmitted by way of a brake operating device 107 with a brake pedal and an actuating travel simulator 109 and determined with redundant travel sensors and/or force sensors 110, 111 and sent through outputs 112, 113, by way of the bus system 105, 106, to two redundant central processors 114, 115 of the central control and regulating unit 80. Further, a parking brake operating device 116 is provided, by means of which also a braking request of the driver can be transmitted by way of the two redundant travel sensors and/or force sensors 110, 111.

In this embodiment of the present invention, the central unit 80—apart from the actuation of the actuators 12, 13 and wheel brake modules 81-84 and the actuation of the actuating force simulator 8—also takes care of evaluating the actuating sensor technology for steering, brake, and parking brake. Wheel brake modules 81-84 and/or the actuators 12, 13 are furnished with regulating instructions on command of the signals. If the central unit 80 fails, data of the actuating sensor technology is also available on the two bus systems. This is because each actuator 12, 13 and wheel brake modules 81-84 dispose of the information meant for them and independently generate correction variables from this information. In addition, the functioning of the steering system and the brake is ensured even upon failure of an energy source 43 or 60. One energy source respectively feeds one actuator and two wheel brake modules as well as each one redundant unit of the actuating sensor technology for the steering system and the brake by way of two separate independent current lines 117, 118. In total, the system thereby provides a high degree of fail safety as well as sufficient ‘emergency functions’ in the case of fault.

In addition, the central unit 80 permits an active intervention into the control or regulation of brake and steering system in response to the driver's request. An additional intervention into the engine management is also provided in the sense of the present invention, as it can be performed already in driving dynamics control systems (ESP) or traction slip control systems (TCS). The system of the present invention can support the driver and steer the vehicle, brake each individual wheel, or accelerate the vehicle with respect to optimum safety and driving comfort. Therefore, the system is also best suited for use on driver assist systems, such as automatic speed control (cruise control, CC) or collision avoidance and distance control (ACC, AICC).

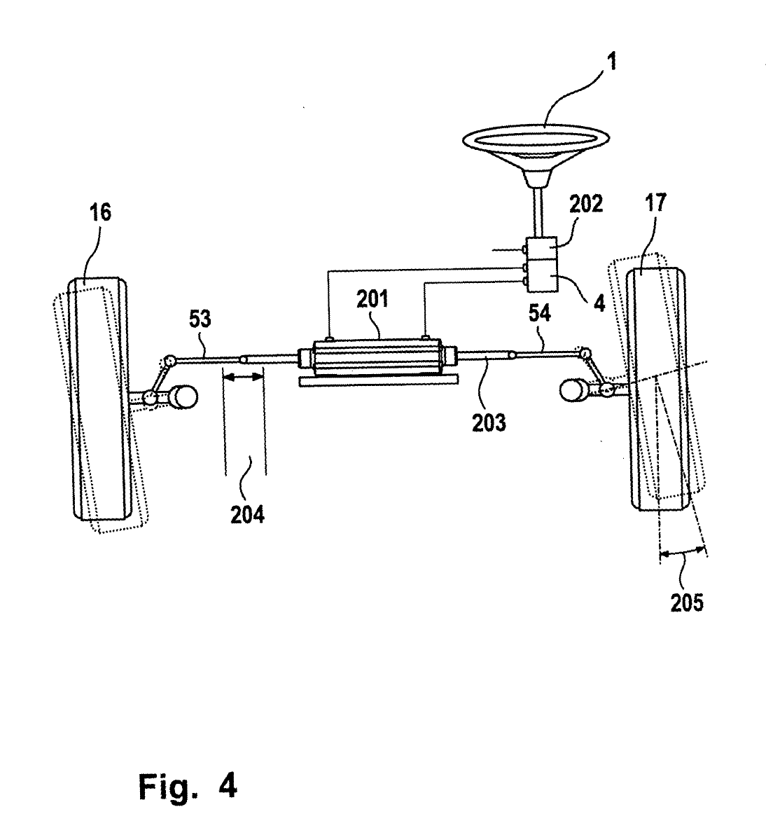

FIG. 4 shows the vehicle steering system of the present invention with an axle guide module 201, wherein two actuators 12, 13 are arranged being actuated by the central control unit 4. A defined steering angle 205 is adjusted by readjustment of a steering rod 203 by a defined adjustment travel 204.

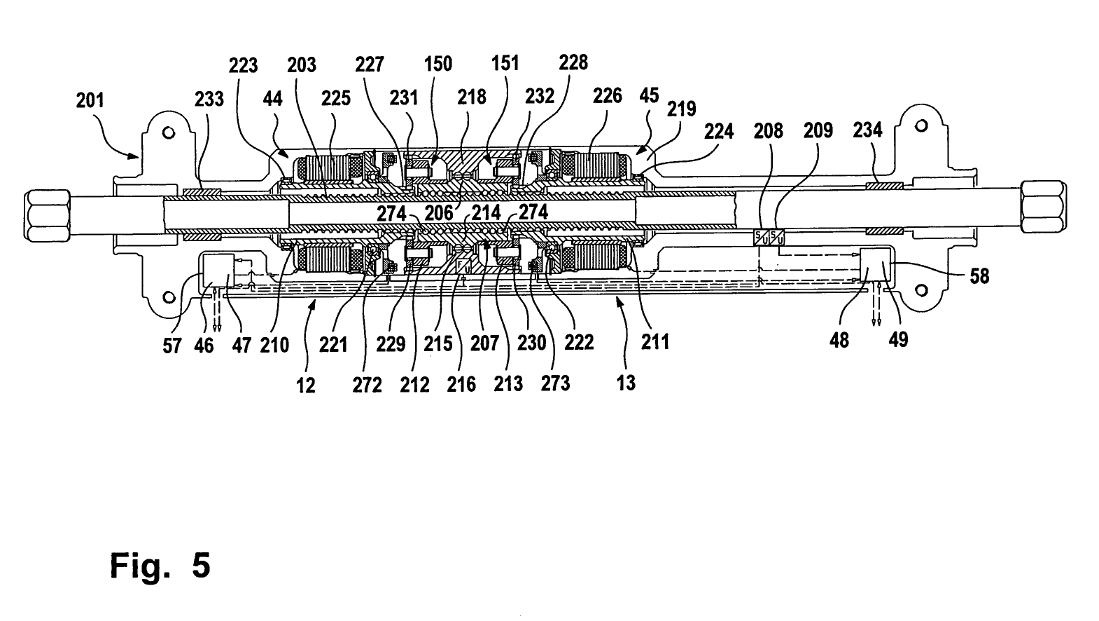

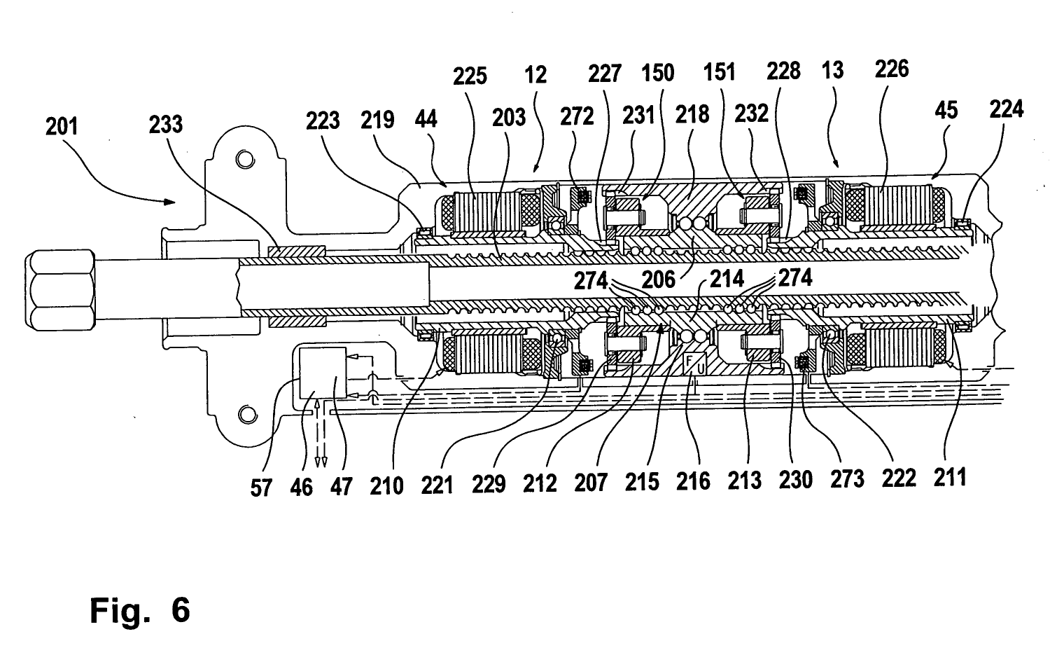

An axle guide module 201 with two actuators 12, 13 and a continuous steering rod are shown in a cross-section in FIG. 5 and FIG. 6.

The actuators 12, 13 include two electric motors 44, 45 arranged concentrically around the steering rod 203. The redundant drive concept is realized by the two electric motors 44, 45. The two electric motors 44, 45 drive a screw thread 207 and the steering rod 203 that is configured as a screw thread rod at least in the area of the gear units or electric motor modules by way of transmission units, herein preferably two planetary gears 50, 51 by way of a centrically seated nut 206. The steering rod 203 herein has a continuous design, with the result that the wheels 16, 17 are coupled to each other in a kinematic way. Other gear unit constructions may also be used for the transmission units which are appropriate to convert the drive torque into a setting force and a steering movement of the wheels 16, 17 coupled by way of the two tie rods 53, 54. It is likewise possible in the sense of the present invention to replace the gear units 50, 51 by two clutches as transmission units.

Two redundant travel sensors 208, 209 sense the steering rod travel 204 redundantly. After a plausibility poll, the central control unit 4 will determine a set value for the steering angle (set value) to be adjusted according to the sensed travel of the steering rod 203 (actual value). The central control unit 4 is preferably arranged in the area of the hand steering wheel 1 (see FIG. 4). Alternatively, the central control unit 4 may also be favorably integrated into the axle guide module 1. When the demanded set value is reached, i.e., the steering angle 205 of the wheels 16, 17 to be adjusted, a moment holding the wheels in a stable position will develop at the electric motors depending on the tie rod forces that act.

In the mode of operation described above, two rotors 210, 211 associated with the electric motors 44, 45 are rotatorily form-lockingly coupled in a clearance-free manner to the threaded nut 206 of the screw thread 207 by way of the two planetary gears 50, 51. This means that the two electric motors 44, 45 are also interconnected and can drive the steering rod 203 in parallel in the mode of operation described hereinabove (normal steering function).

In a case of a fault, with an electric motor 44 or 45 failing, the still operative electric motor will assume the task of driving. For this purpose, the electronic units 46-49 of the actuators 12, 13 that control the electric motors 44, 45 by way of electric motor actuation controls 272, 273 have a redundant design. Due to the one still operative electric motor, the screw thread 207 may thus perform the setting movement of the steering rod 203 by way of the balls 274. The mechanic coupling by way of the threaded nut 206 and the screw thread 207 will then entrain the assemblies of the defective actuator purely mechanically.

From this results as a basic advantage of the axle guide module 201 of the present invention and the vehicle steering system of the present invention that, upon failure of an electric motor, e.g. electric motor 44, e.g. due to failure of the electric energy supply or the failure of an electronic assembly of the central control unit 4 or the actuator itself, the still operative actuator along with the other operative electric motor, i.e., electric motor 45 in this example, will assume the entire steering function of the axle guide module 201 along with the redundantly provided electric motor control when the driver has a steering request. Another advantage is that the two wheels are directly interconnected in a clearance-free manner by way of the steering rod 203 due to the driven nut 206 of the screw thread 207. The flux of force thus extends directly to the wheels 16, 17 by way of the steering rod 203 and the tie rods 53, 54. Thus, also the two wheels 16, 17 are interconnected in a clearance-free fashion.

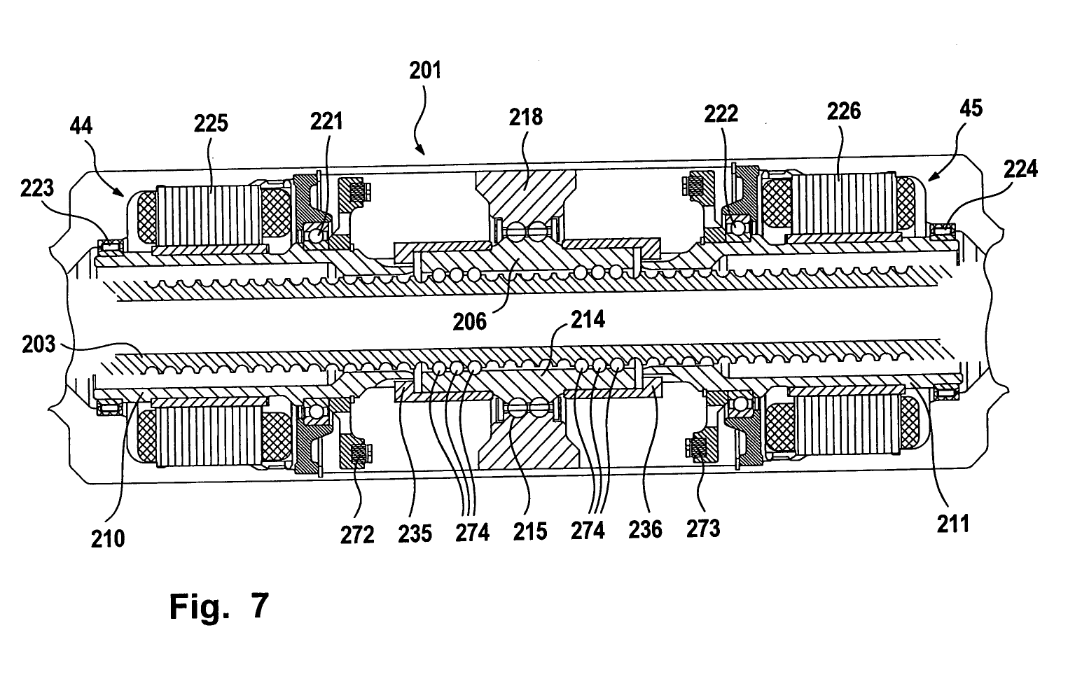

An inner ring 214 of an axial angular ball bearing 215 is provided as an accommodation of the threaded nut 206 of the screw thread 207 and as an accommodation of planet carriers 212, 213 of the planetary gears 44, 45, or in the case of the embodiment with a clutch (see FIG. 7) as an accommodation for the clutch. Thus, the axial angular ball bearing forms a functional assembly with the screw thread 207 and the gear units 44, 45 as an accommodation for the threaded nut 206 and the planet carriers 212, 213 or clutch (see FIG. 7). The axial angular ball bearing 215 will take up the resulting setting force of the steering rod 203 and introduce it into the housing 219 of the axle guide module 201 by way of an outer ring 218 of the axial angular ball bearing 215.

At least one force sensor 220 for sensing the effective setting forces may be arranged in the outer ring 218 of the axial angular ball bearing 215. The second electromechanical actuating force simulator 8 can adjust a defined manual force at the hand steering wheel 1 for the driver (feedback of forces) in accordance with the measured forces hereinabove. The force sensor 220 may additionally be used for a plausibility check and a system check.

The rotors 210, 211 are mounted in the housing 219 preferably by way of immovable bearings 221, 222 and movable bearings 223, 224. This achieves a mounting support of the rotors 210, 211 free from transverse forces. Stators 225, 226 associated with the electric motors 44, 45 are also accommodated in the housing 219. Also, a small air slot between the rotors 210, 211 and the stators 225, 226 can be realized thereby, what has a positive effect on the total efficiency. Sun wheels 227, 228 of the planetary gears 50, 51 are additionally provided as components of the rotors 210, 211. The sun wheels 227, 228 drive the planet carriers 212, 213 by way of planet wheels 229, 230. The sun wheels 227, 228 are supported on ring gears 231, 232 which are integrated in the outer ring 218 of the axial angular ball bearing 215. The drive torque of the screw threads 207 and adjoining the steering rod 203 is performed by way of two anti-rotation mechanisms 233, 234 integrated in the housing 219, with the anti-rotation mechanisms 233, 234 also performing a linear bearing function of the steering rod 203. Preferably, this obviates the need for an anti-rotation mechanism 233 or 234 on either side.

An embodiment of the axle guide module 201 shown in FIG. 5 and FIG. 6 is illustrated in FIG. 7 wherein clutches 235, 236 have been substituted for the gear units 50, 51 as transmission elements. This means that the tie rods are driven directly by way of the two clutches 235, 236 in this arrangement (direct drive). This ‘direct drive’ is in particular provided for relatively light, small vehicles with low loads on the front axle, requiring only relatively low setting forces to steer the wheels. Favorably, this permits reducing the effort and structure, principally resulting in enhanced reliability and lower producing costs.

The steering rod 203 of the axle guide module 201 shown hereinabove is not divided, with the result that the wheels 16, 17 are directly coupled to the tie rods 112, 113. However, it is likewise arranged for in the present invention to provide an electromechanical axle guide module 201 with tie rods 112, 113 that are preferably uncoupled electromechanically, at least in part, in order to permit a unilateral steering angle adjustment, for example, for a driving-dynamics control intervention.

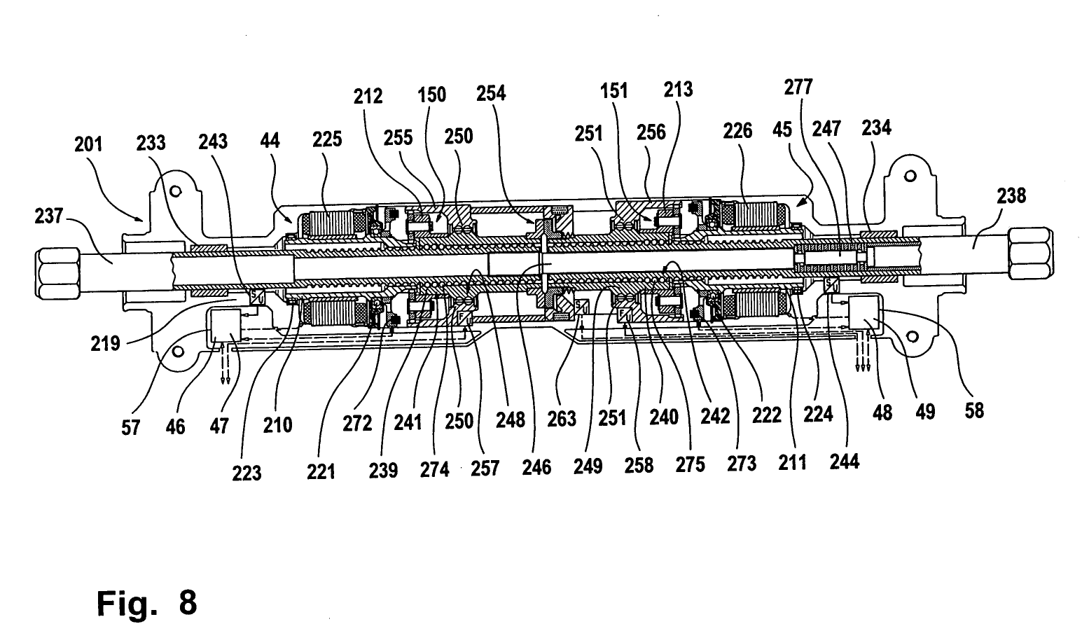

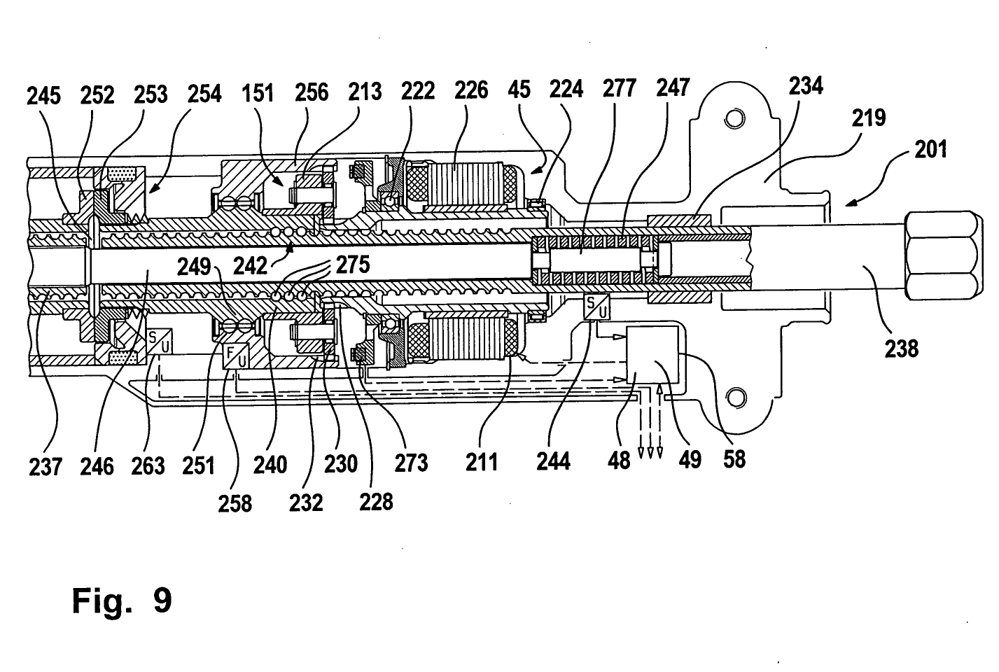

One example for a preferred embodiment of an axle guide module for partly uncoupled tie rods 112, 113 is shown in FIG. 8 and FIG. 9.

The axle guide module 201 includes two electric motors 44, 45 concentrically arranged around the two steering rods 237, 238. The steering rods 237, 238 are configured as screw thread rods. A redundant drive concept is realized by the two electric motors 44, 45. By way of two planetary gears 50, 51, the two electric motors 44, 45 drive two nuts 239, 240 of two screw threads 241, 242 and convert the drive torque into a setting force and a steering movement of the wheels 16, 17 coupled by the two tie rods 53, 54.

A redundant travel sensor 243, 244 is arranged at an actuator 12, 13 in each case in order to sense the travels of the two steering rods 237, 238. In accordance with the determined steering rod travels, the central control unit 4 computes a set value for controlling the steering angle 205 and the second actuating force simulator 8. The central control unit 4 can be integrated in the area of the hand steering wheel 1 or within the axle guide module 201. When the demanded set value, i.e., the steering angle 205 of the wheels 16, 17, is reached, a wheel-stable holding torque will develop at the electric motors 44, 45 depending on the active tie rod forces.

The steering rods 237, 238 preferably have a separation zone 245 in the middle of the axle guide module 201. The steering rods 237, 238 are coupled by a coupling rod 246 that is rigid with one of the two steering rods (steering rod 237 herein) and partly elastically arranged within the other steering rod (steering rod 238 herein) by way of a biased compression spring 247 limited in its travel. Therefore, the other steering rod 238 is configured as a hollow cylinder at least in the section where it is possible for the coupling rod 246 to move. The two steering rods 237, 238 act below the adjusted spring bias, in the direction of movement of the steering rod travel 204 (translatorily), like one single, rigid continuous steering rod.

The two threaded nuts 239, 240 of the two screw threads 241, 242 are form-lockingly coupled rotatorily to each other in a clearance-free manner by way of two inner rings 248, 249 of two axial angular ball bearings 250, 251 and two clutch discs 252, 253 of a normally closed electromechanical clutch 254. In the normal steering mode both electric motors 44, 45 are interconnected by way of the clutch 254 and can thus drive the steering rods 237, 238 in parallel. In a case of malfunction, that means upon failure of an electric motor 44, 45, the intact electric motor—due to the redundantly designed electric motor actuation control—will assume the entire setting movement of the two steering rods 237, 238 (redundant drive concept). The defective actuator 12, 13 will then be entrained purely mechanically.

Preferably, the inner rings 248, 249 of the axial angular ball bearings 250, 251 are designed as seats of the threaded nuts 239, 240, as seats of the two planet carriers 212, 216, and as seats of the two clutch discs 252, 253, all together forming a functional assembly. In this arrangement, the axial angular ball bearings 250, 251 take up the developing setting forces of the steering rods 237, 238 and introduce them into the housing 219 by way of two outer rings 255, 256 of the two axial angular ball bearings 250, 251. Two force sensors 357, 358 may be integrated in the outer rings 255, 256 for sensing the setting forces and for the feedback of the active setting forces at the second actuating force simulator 8. The force sensors 357, 358 may be used for plausibility checks and system checks in addition.

Rotors 210, 211 in the planetary gears 50, 51 are supported by way of immovable bearings 221, 222 and the movable bearings 223, 224 in the housing 219 free from transverse forces, the said housing additionally accommodating the stators 225, 226. A small air slot between rotor and stator is realized this way, what has a positive effect on the total efficiency. Also, sun wheels 227, 228 of the planetary gears 50, 51 are components of the rotors 210, 211 and drive planet carriers 212, 213 by planet wheels 229, 230 that are supported on ring gears 231, 232 integrated in the outer rings 139, 140 of the axial angular ball bearings 250, 251. The developing drive torque is supported at the spindle-shaped sections of the steering rods 237, 238 by way of the two anti-rotation mechanisms 233, 234 integrated in the housing 219 and also fulfilling a linear bearing function of the steering rods 237, 238.

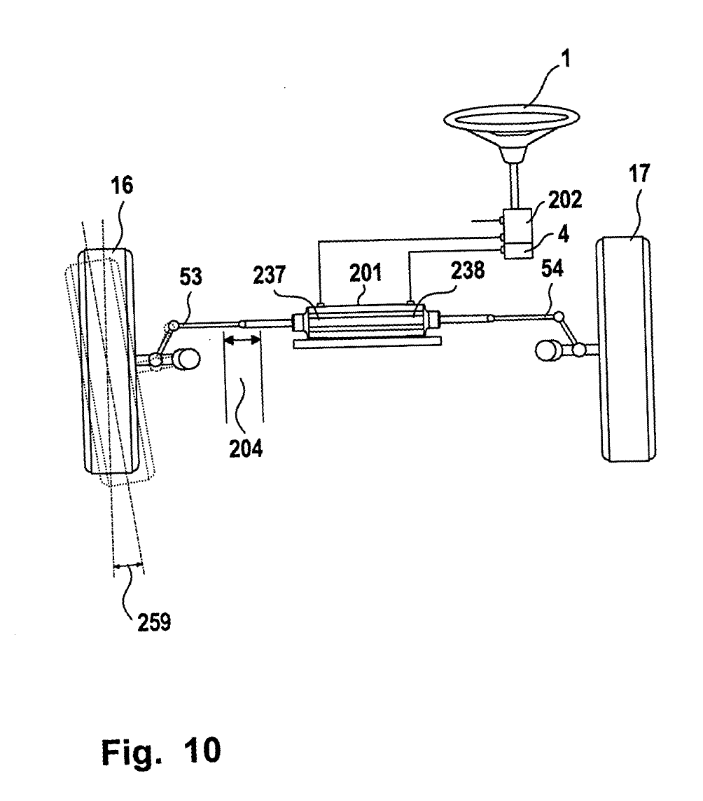

For a dynamic steering intervention, for example, a unilateral steering angle adjustment irrespective of the respectively other wheel may be effected due to the generally independently operable steering rods 237, 238, which is illustrated in FIG. 10. Herein, the left wheel 16 is swung in relation to the right wheel 17 by a difference angle 259.

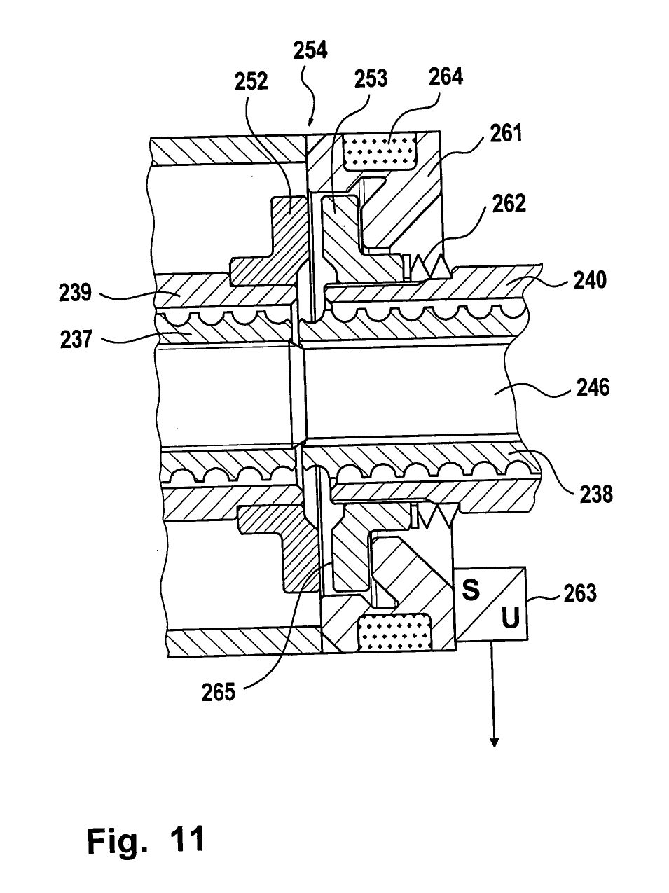

It is also feasible to provide for rotating screw thread rods (not shown) instead of the rotating nut 239, 240 of the screw thread shown in FIG. 11, and force is then transmitted to screw thread rods connected to the tie rods 53, 54 e.g. by way of a planetary gear 150, 151 and interposed propeller shafts. In this case also the housing may have a bipartite design so that each actuator 12, 13 is associated with a housing part. Preferably, the two actuators are coupled to each other by a clutch 52 that permits an individual adjustment of the wheels 16, 17 at least within certain limits.

The electromechanical clutch 254 is illustrated in more detail in FIG. 11. The purpose of the clutch 254 is to permit uncoupling the two steering rods 237, 238 from each other with respect to their possibility of linear movement and to thereby achieve a unilateral steering angle adjustment of one wheel. This is done by opening, i.e. energizing the electromechanical clutch 254. When the clutch 254 is open, the two nuts 239, 240 are rotatorily isolated from each other, and each electric motor 44, 45 can adjust a requested steering angle difference 359 in the adjustment range 260 that is mechanically limited to an allowable degree, the said adjustment taking place in accordance with values determined by the force sensors and redundant travel sensors. Apart from the clutch discs 252, 253, the clutch 254 includes a pole element 261, a compression spring 262, a clutch sensor 263, and a coil 264. The two clutch discs 252, 253 can be positively connected to each other, preferably at their clutch surface 265, for a safe transmission of high torques. Further, the clutch surface 265 can be given a defined shaping so that it is locked only in one position, preferably in a normal position of the two steering rods 237, 238. When the coil 264 of the pole 261 rigidly connected to the housing 219 is energized, a clutch disc 253 is drawn against the compression spring 262 and releases the clutch 254. The disengagement and engagement action is sensed and monitored by the clutch sensor 263. The clutch disc 252 is configured as an armature and can axially displace on the inner ring 248 of the one axial angular ball bearing 250. Torque is transmitted by the shaping between clutch disc 252 and inner ring 248 of the axial angular ball bearing 250. When a steering regulation of a steering angle difference is completed, both electric motors 44, 45 will return the steering rods 237, 238 into their normal or initial position, the coil current declines, and the two clutch discs 252, 253 are locked in their normal or initial position by the compression spring 262. Clutch sensor 263 senses this engagement action. The further regulation of the steering angle 205 is then executed by way of the normal steering mode.

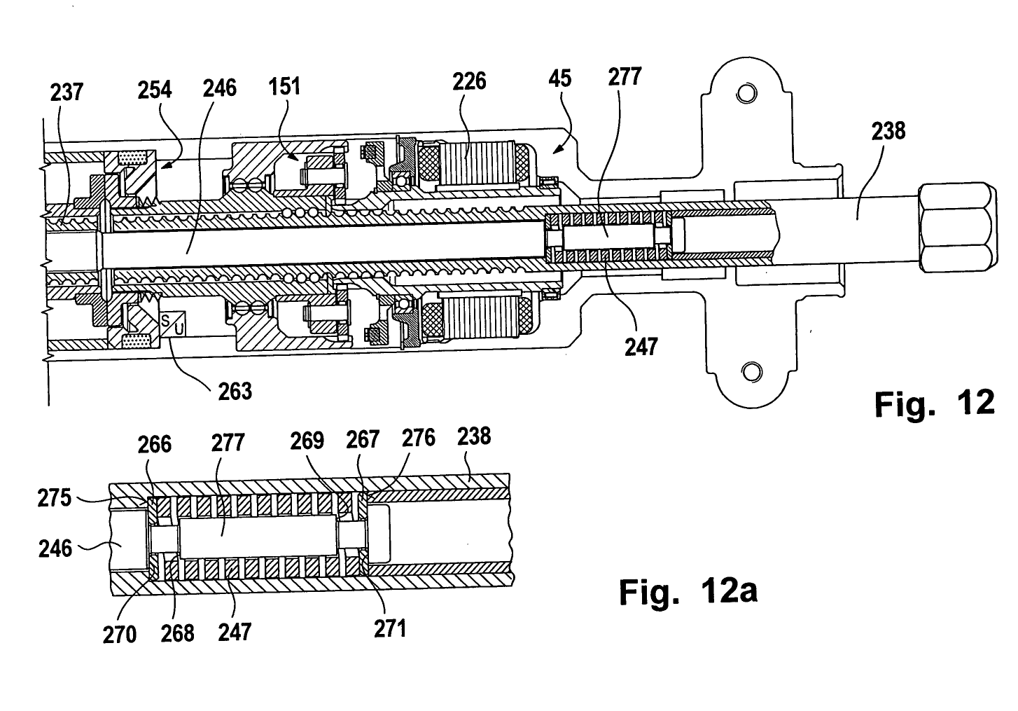

The mode of operation of the axle guide module shown in FIGS. 8 and 9 is shown in detail in FIG. 12 to FIG. 14. When an engine module fails, the safety concept arranges for the two steering rods 237, 238 of the wheels 16, 17 to be mechanically reset into their initial position by the assisting spring force 272, and the two threaded nuts 239, 240 are locked in their normal position by the clutch 254 which preferably has a form lock (see FIG. 12 and FIG. 12a). The compression spring 247 has a maximum length, it bears against the two outer stops of the coupling rod 270, 271 and against the two stops of the hollow shaft 275, 276 by way of the two entrainer discs 266, 267. The intact actuator will now assume the normal steering function with the operative electric motor.

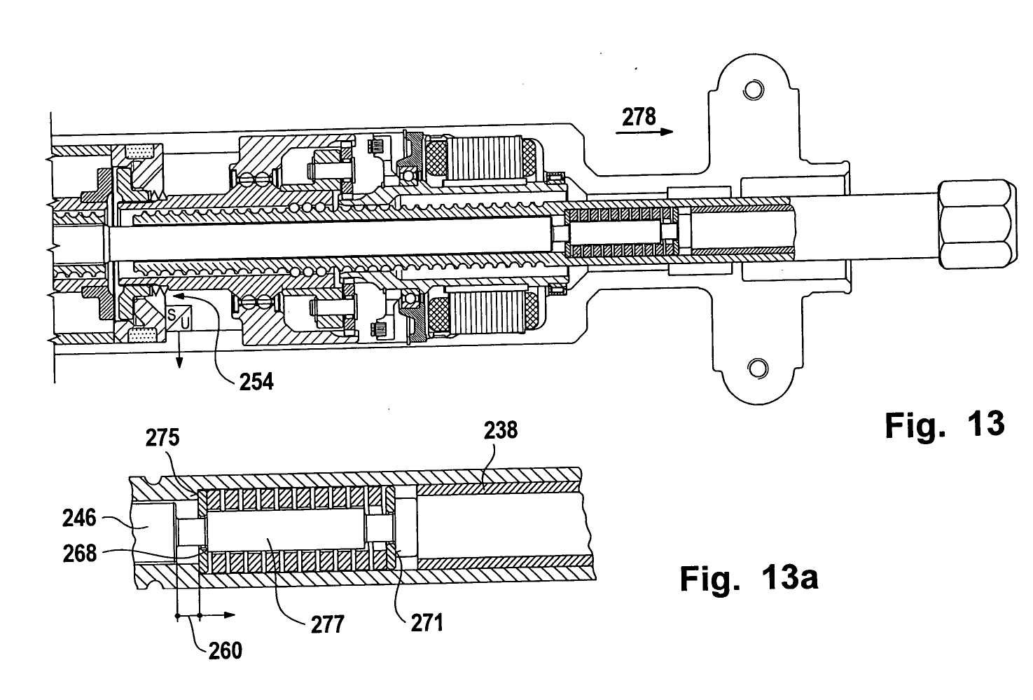

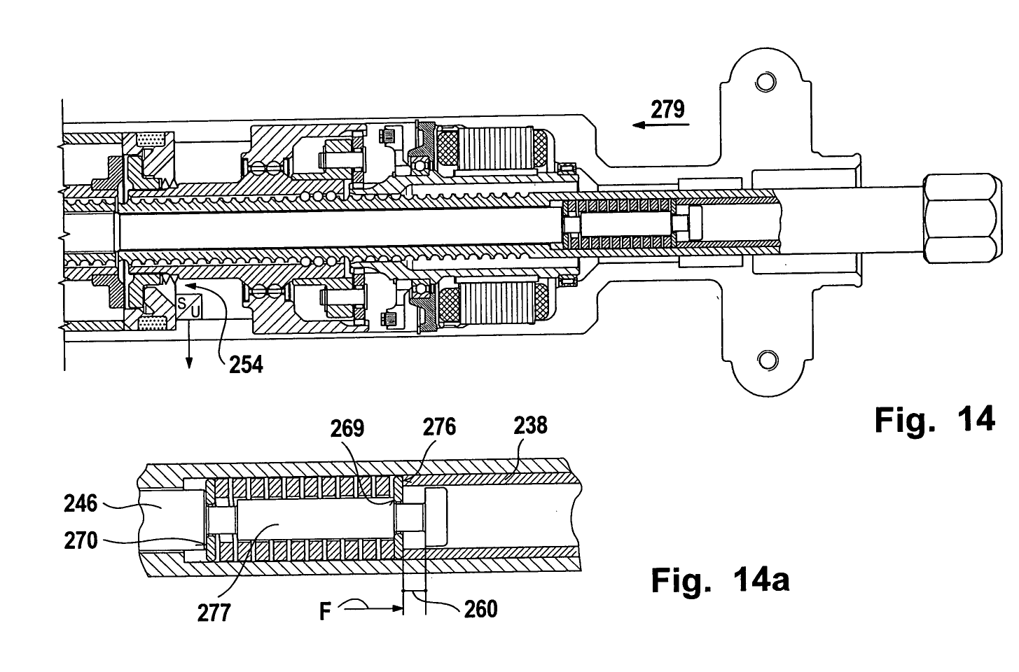

The independent adjustment range of the steering rod is principally predefined by the design and construction of the components connecting the two steering rods 237, 238, especially the coupling rod 246 and the compression spring 247 and their adjacent components (see FIG. 13 to FIG. 14a). The allowable mechanical adjustment range 260 of the two steering rods 237, 238 during the steering angle difference control is realized by the integrated, anchored and biased compression spring 247 in connection with two entrainer discs and by way of inner stops 268, 269 and outer stops 270, 271 of the coupling rod and stops 275, 276 of the steering rod hollow shaft 238. The steering angle difference cannot be adjusted purely mechanically by way of this boundary, that means, the two wheels 16, 17 are rigidly coupled to each other above this area (safety concept). In the steering angle difference control, the two steering rods 237, 238 are shifted relative to one another, and the compression spring 247 may be biased further until mechanic stops 270, 271, this biasing action being done by way of the coupling rod 246, i.e. said's end piece 277, and two entrainer discs 266, 267. This function is ensured in both directions by the external captivation of the compression spring 247 in the steering rod 238 and the internal captivation of the compression spring 247 by the coupling rod 246. The steering angle difference is mechanically limited by a first (see FIGS. 13, 13a) and a second (see FIGS. 14, 14a) end position.

When the steering rod 238 shown in FIGS. 12, 12a is moved to the right (in the direction of arrow 278) and the steering rod 246 is not moved, the first stop 275 of hollow shaft 238 will displace the left entrainer disc 266 to the right, and the spring which is retained stationarily on its right-hand side by way of the second outside stop 271 of the stationary end piece 277 of the coupling rod 246, is compressed in opposition to the spring force until the first end position shown in FIGS. 13, 13a is reached. In the first end position (FIGS. 13, 13a) the compression spring 247 has a minimum length and, by way of the two entrainer discs 266, 267) bears against the first stop 275 of the hollow shaft 238, on the one hand, and against the second outside stop 271 of the end piece 277 of the coupling rod 246, on the other hand.

When the steering rod 238 shown in FIGS. 12, 12a is moved to the left (in the direction of arrow 279) and the steering rod 246 is not moved, the second stop 276 of the hollow shaft 238 will displace the right entrainer disc 267 to the left, and the spring 247 which is retained stationarily on its left-hand side by way of the left entrainer disc 266 caused by the first outside stop 270 of the stationary end piece 277 of the coupling rod 246, is compressed in opposition to the spring force until the second end position shown in FIGS. 14, 14a is reached. In the second end position (FIGS. 14, 14a) the compression spring 247 also has a minimum length and, by way of the two entrainer discs 266, 267, bears against the second stop of the hollow shaft 276, on the one hand, and against the first outside stop 270 of the end piece 277 of the coupling rod 246, on the other hand. This means that an additional engine torque of the electric motors 44, 45 must be generated for the steering angle difference control by an existing and rising spring force produced by the compression spring 247.

The special advantage of this embodiment resides in the ability of directly driving the threaded nuts 239, 240 of the screw threads 241, 242, with the result that the two wheels 16, 17 are interconnected devoid of clearance by way of the coupling rod 246 integrated in the steering rods 237, 238 and the integrated preloaded compression spring 247. This implies that the two steering rods 237, 238 are considered as being one part under functional aspects beneath the spring preload. Further, this system provides for a safe clutch concept for the steering angle difference control owing to a clutch 254 that is positively locked in one position, a mechanically limited adjustment range 260 and a biased compression spring 247 that acts with the coupling rod 246.

FIG. 15 shows an axle guide module having two steering rods 237, 238 adjustable by way of two actuators 12, 13. In contrast to embodiments illustrated hereinabove, wherein the two actuators 12, 13 have been accommodated in one joint housing 219, the two actuators in FIG. 15 are arranged in each one housing 280, 281 and interconnected by a clutch 282.

List of Reference Numerals:

1 hand steering wheel

2,3 redundant sensors at the hand steering wheel

4 central control unit

5,6 data transmission lines from the sensors at the hand steering wheel

7 passive actuating force simulator

8 electromechanical actuating force simulator

9 data transmission line to the electromechanical actuating force simulator

10 vehicle speed sensing device

11 data transmission line to the central control unit

12,13 actuators

14,15 data transmission lines to the actuators

16,17 steerable wheels

18 steerable axle

19,20 redundant travel sensors of the actuators

21,22 data transmission lines from the actuators

30,31 A/D converters of the sensors at the hand steering wheel

32,33 output A/D converters of the sensors at the hand steering wheel

34,35 bus system of the steering system

36 vehicle bus system (CAN)

37 motor of electromechanical actuating force simulator

38 gear unit of electromechanical actuating force simulator

39 axis of hand steering wheel

40,41 processors of central control unit

42 switch of electromechanical actuating force simulator

43 first electric energy source

44,45 motors of the actuators

46-49 processors of the actuators

50,51 gear units of the actuators

52 clutch of the actuators

53,54 tie rods

55,56 inputs and outputs of the actuators

57,58 electronic units of the actuators

59 input and output to the vehicle bus system (CAN)

60 second electric energy source

61,62 electronic modular units of the electric energy sources

63,64 input and output of the electric energy sources

65,66 vehicle batteries

67,68 lines for the power supply of the components

69,70 switches of the actuators

71 vehicle generator

80 central control and regulation unit (central unit)

81-84 wheel brake modules

85-88 actuators of the wheel brake modules

89-92 gear units of the wheel brake modules

93-100 processors of the wheel brake modules

101-104 inputs and outputs of the wheel brake modules

105-106 brake and steering bus systems

107 brake operating device

108 brake pedal

109 actuating travel simulator of the brake operating device

110,111 sensors of the brake operating device

112,113 outputs of the sensors of the brake operating device

114,115 central processor of the central control and regulation unit (central unit)

116 operating device of parking brakes

117,118 lines for the power supply of the components

119 central vehicle processor

150,151 rotation/rotation gear units of the actuators

201 axle guide module

202 actuating force simulator (steering simulator)

203 steering rod

204 steering rod travel

205 steering angle

206 nut of the screw thread

207 screw thread

208,209 travel sensors of the steering rod

210,211 rotors of the motors

212,213 planet carriers

214 inner ring

215 axial angular ball bearing

218 outer ring

219 housing

220 force sensor

221,222 immovable bearing

223,224 movable bearing

225,226 stators

227,228 sun wheels

229,230 planet wheels

231,232 ring gear

233,234 anti-rotation mechanisms

235,236 clutches

237,238 steering rods

239,240 nuts of the screw threads

241,242 screw threads

243,244 travel sensors

245 separation zone of the steering rods

246 coupling rod

247 compression spring of the coupling rod

248,249 inner rings of the axial angular ball bearing

250,251 axial angular ball bearing

252,253 clutch discs

254 electromechanical clutch

255,256 outer rings of the axial angular ball bearing

257,258 force sensors

259 steering angle difference

260 mechanically limited setting range

261 pole element

262 compression spring of the electromechanical clutch

263 clutch sensor

264 coil

265 coupling surface

266, 267 entrainer discs

268, 269 inner stops of the coupling rod

270, 271 outer stops of the coupling rod

272, 273 motor actuation control

274 balls of the screw thread

275, 276 mechanic stops of the steering rod hollow shaft

277 end piece of the coupling rod

278, 279 direction of movement of the steering rod

280, 281 housing of the actuators

282 clutch between the actuators

1. Vehicle steering system including
a steering operating device operable by the driver, in particular a hand steering wheel,
at least one actuating force simulator,
each one electromechanical actuator for controlling of each steerable wheel of a wheel pair on a steerable vehicle axle at the right and left side of a vehicle body,
with means which, in the event of failure or a malfunction of one of the two actuators associated with a steerable vehicle axle, ensure the control of the vehicle wheels of this vehicle axle by the respectively other, still functioning actuator,
with at least one set-value transducer for a steering angle being adjusted that is operable by the steering operating device,
with at least one actual-value transducer recording the steering angle of the vehicle wheels,
with a central control unit which controls the electromechanical actuators in dependence on a comparison of a signal of the actual-value transducer (actual value) with a signal of the set-value transducer (set value),
and with a data transmission unit which establishes a data communication between the central control unit and the electromechanical actuators.

2. Vehicle steering system as claimed in claim 1,
characterized in that each electromechanical actuator is respectively fed by an independent energy supply source.

3. Vehicle steering system as claimed in claim 1 or 2,
characterized in that the central control unit has a ‘fail-silent’ design and includes a redundant processor unit.

4. Vehicle steering system as claimed in any one of claims 1 to 3,
characterized in that the actuators are designed to be ‘fail-silent’ and include at least one electromechanical actuator each and one redundant electronic modular unit each.

5. Vehicle steering system as claimed in claim 4,
characterized in that the electronic modular units of the actuators perform a fault detection based on local, actor-related signals such as actor current or actor position and, when a fault is detected, will emit a corresponding report to the vehicle steering system and disconnect the faulty actuator.

6. Vehicle steering system as claimed in any one of claims 1 to 5,
characterized in that the vehicle steering system includes two set-value transducers for the steering angle being adjusted and two actual-value transducers that record the steering angle of the vehicle wheels.

7. Vehicle steering system as claimed in any one of claims 1 to 6,
characterized in that the set-value transducer(s) for the steering angle being adjusted and the actual-value transducer(s) recording the steering angle of the vehicle wheels have a redundant design.

8. Vehicle steering system as claimed in any one of claims 1 to 7,
characterized in that a data bus that is of double design at least between the actuators and the central control unit is provided as a data transmission unit.

9. Vehicle steering system as claimed in any one of claims 1 to 7,
characterized in that each one data bus is provided as a data transmission unit between the actuators and the central control unit.

10. Vehicle steering system as claimed in any one of claims 1 to 9,
characterized in that the central control unit is connected to a vehicle bus system, in particular CAN, to receive data about the current vehicle condition in particular.

11. Vehicle steering system as claimed in any one of claims 1 to 10,
characterized in that the steering operating device is connected to a mechanical or mechanic-hydraulic first actuating force simulator in terms of driving, for the purpose of simulating a certain predefined operating resistance, and that the steering operating device is connected in terms of effect to an electrically operable, preferably parameter-responsive second actuating force simulator which controls the second actuating force simulator in accordance with at least the actual value and/or, possibly, further signals, in particular dynamic vehicle condition signals, such as vehicle speed, vehicle yaw angle, or road condition signals.

12. Vehicle steering system as claimed in any one of claims 1 to 11,
characterized in that the central control unit is connected to an electronic vehicle brake system, especially an electromechanical brake system (EMB).

13. Vehicle steering system as claimed in claim 12,
characterized in that the central control unit of the vehicle steering system and a central control unit of the electronic vehicle brake system are arranged as individual modules in one joint housing.

14. Vehicle steering system as claimed in claim 13,
characterized in that a joint central control unit is provided for the vehicle steering system and the electronic vehicle brake system.

15. Vehicle steering system as claimed in any one of claims 1 to 14,
characterized in that the respectively two electromechanical actuators for controlling each one steerable wheel of a wheel pair on a steerable vehicle axle at the right and left side of a vehicle body are configured as an axle guide module in connection with at least one steering rod.

16. Axle guide module for a vehicle steering system, in particular as claimed in any one of claims 1 to 15, including two electromechanical actuators having one electric motor each and being associated with each one steerable wheel of a wheel pair of a steerable vehicle axle at the right and left side of a vehicle body and being connectable with each other by way of a coupling device so that the two steerable wheels are adapted to be directed by way of one single actuator.

17. Axle guide module as claimed in claim 16,
characterized in that the vehicle steering system includes at least one steering rod designed as a thrust rod which, in its extension, is connectable to tie rods for the two steerable wheels and wherein the two electric motors are provided coaxially relative to the steering rod axis, each motor including a rotor which is connected to a rotation/translation converter by way of a transmission device for introducing an engine torque to the at least one steering rod in order to ensure the steering function of the axle guide module by way of displacing the at least one steering rod upon actuation of at least one electric motor.

18. Axle guide module as claimed in claim 16 or 17,
characterized in that the transmission device includes means for the direct coupling to the rotation/translation converter.

19. Axle guide module as claimed in any one of claims 16 to 18,
characterized in that the rotation/translation converter is a threaded gear, preferably a screw thread.

20. Axle guide module as claimed in any one of claims 16 to 19,
characterized in that the rotation/translation converter is connected in terms of driving to at least one steering rod (threaded rod) which is configured as a thread rod at least in an area or partial area of the axle guide module, said steering rod being encompassed by at least one threaded nut and connected thereto by way of rollers having a profile that mates with the thread of the at least one threaded rod.

21. Axle guide module as claimed in any one of claims 16 to 20,
characterized in that the transmission devices are drive units or clutches, preferably planetary gears.

22. Axle guide module as claimed in any one of claims 16 to 21,
characterized in that the electric motor comprises a stator with a winding coaxially relative to the steering rod and includes a rotor pivoted about the stator and having permanent magnets, preferably rare earth magnets, especially cobalt-samarium or neodymium magnets.

23. Axle guide module as claimed in any one of claims 16 to 22,
characterized in that the rotor of the electric motor is form-lockingly rotatorily coupled to the threaded nut of the threaded gear in a clearance-free manner by way of the transmission device.

24. Axle guide module as claimed in any one of claims 16 to 23,
characterized in that the rotor of the electric motor is configured as a part of the transmission device, preferably as a sun wheel of a planetary gear, at least in a partial area.

25. Axle guide module as claimed in any one of claims 16 to 24,
characterized in that at least two electronic units are associated with each actuator, and in the event of a fault of one of the two electronic units, the respectively other still operative electronic unit assumes the control of the actuator.

26. Axle guide module as claimed in any one of claims 16 to 25,
characterized in that the turning movement of the wheels is performed by the still operative actuator or the electric motor, respectively, in the event of a fault of an actuator or an electric motor, respectively, and the modular unit of the defective actuator is entrained purely mechanically due to a mechanical coupling by way of the coupling device, in particular by means of the at least one threaded nut and the at least one threaded gear.

27. Axle guide module as claimed in any one of claims 16 to 26,
characterized in that at least one bearing, preferably an axial angular ball bearing, is provided to accommodate the setting forces acting on the at least one steering rod, the said bearing having an inner ring as a seat for the threaded nut and at least one component of the transmission device, preferably of planet carriers of a planetary gear or a clutch, as well as an outer ring to introduce the setting forces that develop into a housing or a component of the axle guide module that is operatively connected to the housing.

28. Axle guide module as claimed in claim 27,
characterized in that at least one force sensor is associated with the outer ring of the bearing in order to sense the active setting forces and to provide a feedback about these determined setting forces to the manual actuating device, preferably the hand steering wheel of the vehicle steering system.

29. Axle guide module as claimed in any one of claims 16 to 28,
characterized in that the stator of the electric motor is arranged at a housing or a component of the axle guide module that is operatively connected to the housing, and the rotor of the electric motor is pivoted by way of an immovable bearing and a movable bearing at a housing or a component of the axle guide module that is operatively connected to the housing.

30. Axle guide module as claimed in any one of claims 18 to 29,
characterized in that each actuator includes as transmission devices a planetary gear having a sun wheel that is designed as a component part of the rotor and is supported on a ring gear that is a part of the outer ring of a bearing for accommodating the setting forces.

31. Axle guide module as claimed in any one of claims 16 to 30,
characterized in that the two actuators are provided with one joint steering rod configured as a thrust rod, preferably one joint threaded rod, and one joint rotation/translation converter, in particular one joint threaded nut and joint roll bodies arranged therebetween, in order to ensure the steering function of the axle guide module by way of displacing the steering rod upon actuation of at least one actuator.

32. Axle guide module as claimed in any one of claims 16 to 31,
characterized in that associated with each of the two actuators is respectively one steering rod configured as a thrust rod, preferably each one threaded rod, and each one rotation-translation converter, especially each one threaded nut and roll bodies respectively arranged therebetween, and that associated with both actuators is a coupling device to connect the two actuators and to ensure the steering function of the axle guide module by displacing the two connected steering rods upon actuation of an actuator.

33. Axle guide module as claimed in claim 32,
characterized in that the coupling device includes an electromechanical clutch having clutch discs which are operatively connected to inner rings of two bearings, preferably axial angular ball bearings, which are used to accommodate the setting forces that act on the two steering rods, and that in the de-energized condition the two clutch discs are pressed against each other by an elastical means, preferably a compression spring, and constitute an operative connection between the two rotation/translation converters of the actuators.

34. Axle guide module as claimed in claim 32 or 33,
characterized in that a defined maximum setting range of the two steering rods with respect to each other is predetermined by means of mechanic stops that allow only a defined difference in travel of the two steering rods in relation to each other.

35. Axle guide module as claimed in claim 34,
characterized in that at least one partial area of the one of the two steering rods is configured as a hollow shaft having two stops and a hollow space which is penetrated by a coupling rod connected to the other steering rod, said coupling rod including an end piece close to the hollow shaft that has two inner stops and two outer stops that allow only a defined difference in travel of the two steering rods in relation to each other in interaction with two entrainer discs adapted to bear against the stops and a compression spring that is supported on the entrainer discs.

36. Axle guide module as claimed in claim 35,
characterized in that when the electromechanical clutch is closed, the coupling rod defines an initial position in which the compression spring has a maximum length and is supported by the two entrainer discs on the two outer stops of the coupling rod and the two stops of the hollow shaft, and that when the electromechanical clutch is open, a first and a second end position is defined, thereby fixing the maximum difference in travel of the steering rods, wherein in the first end position, the compression spring has a minimum length and is supported by way of the two entrainer discs on a first stop of the hollow shaft, on the one hand, and on a second outer stop of the coupling rod, on the other hand, and wherein in the second end position, the compression spring has a minimum length and by way of the two entrainer discs is supported on a second stop of the hollow shaft, on the one hand, and on a first outer stop of the coupling rod, on the other hand.
